(19) United States
(12) Patent Application Publication
(10) Pub. No.: US 2016/0000123 A1
(43) Pub. Date: Jan. 7, 2016

(54) READY TO DRINK DAIRY CHOCOLATE BEVERAGES

(71) Applicant: NESTEC S.A, Vevey (CH)

(72) Inventors: Alexander Sher, Dublin, OH (US); Virginie Kapchie, Dublin, OH (US); Jun-Tse Ray Fu, Dublin, OH (US)

(21) Appl. No.: 14/769,867

(22) PCT Filed: Feb. 26, 2014
(86) PCT No.: PCT/EP14/53717

§ 371 Date: Aug. 24, 2015

Related U.S. Application Data
(60) Provisional application No. 61/769,430, filed on Feb. 26, 2013.

(51) Int. Cl. A23L 1/0532; A23C 9/156; A23C 9/15; A23L 1/0534; A23G 1/56

(52) U.S. Cl. CPC A23L 1/0532; A23L 1/0534; A23G 1/56; A23C 9/1516; A23C 9/156; A23V 2002/00

(57) ABSTRACT

Ready to drink dairy chocolate beverages are provided. The beverage can include at least one of milk fat or dairy proteins, a cocoa component, and a stabilizing system comprising microcrystalline cellulose, carboxymethyl cellulose and carrageenan. Milk fat can be present in the beverage in an amount from about 0% to about 1.5% of the beverage and can be the only fat in the beverage. Sugar can be present in the beverage in an amount from about 2% to about 4% of the beverage. The beverage can be aseptic and stable in a homogenous state for at least nine months at 4° C., at least three months at 30° C. and at least one month at 38° C.

### BACKGROUND

The present disclosure generally relates to nutritional products. More specifically, the present disclosure is directed to ready to drink (“RTD”) beverages containing a dairy component and a chocolate component.

The current trend is that consumers are more health conscious and are looking for beverages with less calories but without compromising product taste and texture. In addition, consumers are looking for enhanced mouthfeel, also denoted as richness, texture or creaminess, of the beverages. Thus, many RTD beverages are transitioning from high fat and high sugar versions to versions with less fat and less sugar to limit the calories in the beverage. However, fat and sugar reduction results in a less pleasing mouthfeel of the beverages. Therefore, there is a need for a solution that provides an enhanced mouthfeel of low fat and low sugar RTD dairy chocolate beverages so that the consumer has in increased perception of the texture of the beverage.

At the same time, when improving texture perception of low fat and low sugar RTD dairy chocolate beverages, the long shelf life stability of the beverage cannot be compromised. Such stability is challenging because ingredients added to the beverage to improve mouthfeel typically cause product destabilization, such as undesirable increase of product viscosity and phase separation, e.g. syneresis, layering, creaming and/or sedimentation.

There are no current solutions for shelf stable RTD dairy chocolate beverages with low fat and low sugar content which have a mouthfeel similar to full fat and full sugar beverages. Further, there are no current solutions for aseptic low fat and low sugar RTD dairy chocolate beverages which are shelf stable during the life of the beverage.

For example, U.S. Patent App. Pub. No. 2012/0093980 discloses a protein beverage that contains whey protein concentrate or isolate, milk protein concentrate or isolate, soy protein, caseinate or combinations thereof. The beverage has a stabilizer system which includes carboxymethylcellulose and gellan gum. However, this beverage is a high energy drink and does not solve the issues associated with low fat and low sugar cocoa-containing beverages; the stabilizer system does not improve beverage mouthfeel and does not provide long shelf-life stability of a RTD dairy chocolate beverage.

As another example, PCT App. Pub. No. WO2012/005998 discloses a stabilizer system for use in a RTD whole grain beverage containing carboxymethylcellulose, xanthan gum and gellan gum. In one embodiment, the stabilizing system includes 5 to 20% gellan gum, 1 to 10% xanthan gum and 50 to 90% carboxymethylcellulose. The stabilizer system may be used in milk-based or juice-based whole grain beverages. However, the stabilizer system is formulated to stabilize the starch component which is different from cocoa. Furthermore, the stabilizer does not improve the mouthfeel of the beverages. Moreover, the presence of xanthan gum, especially in combination with carboxymethylcellulose, causes syneresis when cocoa is present.

Therefore, there is a need for aseptic low fat and low sugar RTD dairy chocolate beverages that are shelf stable and have an enhanced mouthfeel that mimics the mouthfeel of full fat and full sugar beverages.

### SUMMARY

The present disclosure generally relates to dairy chocolate beverages. The dairy chocolate beverages can have reduced fat, can have reduced sugar, can be aseptic, can be ready to drink and can have a pleasant mouthfeel. The dairy chocolate beverages can have good physico-chemical stability during ambient storage times e.g., stable for at least nine months at 4° C., at least three months at 30° C. and at least one month at 38° C. The dairy chocolate beverages can also overcome problems with phase separation such as sedimentation, syneresis, creaming, viscosity change, age gelation, and other phase separation/instability issues during different storage conditions over the full life of the dairy chocolate beverages.

In an embodiment, a beverage is provided. The beverage includes: a dairy component; a cocoa component; and a stabilizing system comprising microcrystalline cellulose (MCC), carboxymethyl cellulose (CMC) and carrageenan.

In an embodiment, the MCC and the CMC are present in a ratio from about 1:1 to about 40:1 MCC:CMC; and the MCC+CMC and the carrageenan are present in a ratio from about 0.3:1 to about 20:1 (MCC+CMC):carrageenan.

In an embodiment, the MCC is present in an amount from about 0.02% to about 0.2% of the beverage, the CMC is present in an amount from about 0.005% to about 0.25% of the beverage, and the carrageenan is present in an amount from about 0.01% to about 0.075% of the beverage.

In an embodiment, the carrageenan comprises kappa, iota and lambda carrageenan.

In an embodiment, the cocoa component is present in an amount from about 0.25% to about 1.0% of the beverage.

In an embodiment, sugar is present in the beverage in an amount from about 2% to about 4% of the beverage.

In an embodiment, the cocoa component is selected from the group consisting of natural cocoa, alkalized cocoa and combinations thereof.

In an embodiment, milk fat is present in the beverage in an amount from about 0% to about 1.5% of the beverage. The milk fat can be the only fat in the beverage.

In an embodiment, the beverage comprises the cocoa component, the MCC, the CMC, the carrageenan, milk fat and sugar, and substantially all of the remainder of the beverage is milk.

In another embodiment, a ready to drink aseptic beverage is provided. The beverage includes: a dairy component; a cocoa component; and a stabilizing system comprising microcrystalline cellulose (MCC), carboxymethyl cellulose (CMC) and carrageenan, wherein the MCC and the CMC are present in a ratio from about 1:1 to about 40:1 MCC:CMC; and the MCC, the CMC and the carrageenan are present in a ratio from about 0.3:1 to about 20:1 (MCC+CMC):carrageenan; and the stabilizing system maintains the aseptic chocolate beverage in a homogenous state for at least nine months at 4 ° C.

In an embodiment, the MCC is present in an amount from about 0.02% to about 0.2% of the beverage, the CMC is present in an amount from about 0.005% to about 0.25% of the beverage, and the carrageenan is present in an amount from about 0.01% to about 0.075% of the beverage.

In an embodiment, the beverage includes an amount of sugar reduced by about 40% or more and an amount of fat reduced by about 40% or more relative to typical shelf-stable ready to drink beverages containing cocoa and dairy.

In another embodiment, a method of producing a ready to drink dairy chocolate beverage is provided. The method includes the steps of adding a stabilizing system to a dairy component and a cocoa component, the stabilizing system comprising microcrystalline cellulose (MCC), carboxymethyl cellulose (CMC) and carrageenan.

In an embodiment, the MCC and the CMC are present in a ratio from about 1:1 to about 40:1 MCC:CMC; and the MCC+CMC and the carrageenan are present in a ratio from about 0.3:1 to about 20:1 (MCC+CMC):carrageenan.

An advantage of the present disclosure is to provide an improved ready to drink stable dairy chocolate beverage.

Another advantage of the present disclosure is to provide a ready to drink dairy chocolate beverage that does not have stability issues such as sedimentation, syneresis, creaming, viscosity change, and/or age gelation during storage.

Still another advantage of the present disclosure is to provide a ready to drink dairy chocolate beverage that maintains a pleasant mouthfeel, body, smooth texture, and good flavor without off-notes during the shelf-life.

Yet another advantage of the present disclosure is to provide a ready to drink dairy chocolate beverage that has stability despite reduced fat and reduced sugar.

Another advantage of the present disclosure is to provide a ready to drink dairy chocolate beverage that has reduced fat and reduced sugar but a mouthfeel similar to a full fat and full sugar beverage.

Still another advantage of the present disclosure is to provide a stabilizer system that maintains a cocoa component in suspension in a dairy medium.

Additional features and advantages are described herein, and will be apparent from, the following Detailed Description.

### DETAILED DESCRIPTION

All percentages expressed herein are by weight of the total weight of the beverage composition unless expressed otherwise. All dosage ranges contained within this application are intended to include all numbers, whole or fractions, contained within said range. As used in this disclosure and the appended claims, the singular forms “a,” “an” and “the” include plural referents unless the context clearly dictates otherwise. As used herein, “about” is understood to refer to numbers in a range of numerals. Moreover, all numerical ranges herein should be understood to include all integer, whole or fractions, within the range.

The present disclosure relates to shelf-stable RTD beverages containing cocoa and/or a cocoa-based product and containing one or more dairy ingredients (hereinafter “the beverage” or “the beverages”). The beverages can have reduced fat and/or reduced sugar. For example, the beverages can have an amount of sugar and an amount of fat that are each reduced by about 40% or more relative to typical shelf-stable RTD beverages containing cocoa and dairy. The beverages can be aseptic and can be stabilized by the use of a complex stabilizing system containing microcrystalline cellulose (MCC), carboxymethyl cellulose (CMC) and carrageenan. In a preferred embodiment, the beverages can be shelf-stable for at least nine months at 4° C., at least three months at 30° C. and at least one month at 38° C.

A unique combination of components were surprisingly found for a stabilizing system that can provide reduced fat and/or reduced sugar aseptic RTD dairy chocolate beverages with good physico-chemical stability during storage while also providing good mouthfeel and a pleasant, indulgent taste. The stabilizing system improves the stability of reduced fat and/or reduced sugar aseptic shelf-stable RTD dairy chocolate beverages by helping to avoid phase separation, creaming, syneresis and the like during the storage of the beverage at ambient temperatures as well as other temperatures. It was also surprisingly found that increases in viscosity of the beverage did not correlate with better product stability; in general, according to the Stoke's law, the higher viscosity, the better stability against phase separation (e.g. creaming, sedimentation).

In a general embodiment, the beverage comprises a cocoa component, a dairy component, and a stabilizing system. The cocoa component can include one or more natural cocoas, alkalized cocoas, and/or other cocoa or chocolate based products. In an embodiment, the cocoa component is present in the beverage in an amount from about 0.25% to about 1.0% of the beverage.

The dairy component can include one or more dairy ingredients or dairy substitute ingredients. For example, the dairy ingredients can be milk, milk fat, milk powder, skim milk, milk proteins and combinations thereof. Examples of suitable dairy proteins are casein, caseinate, casein hydrolysate, whey, whey hydrolysate, whey concentrate, whey isolate, milk protein concentrate, milk protein isolate, and combinations thereof. Furthermore, the dairy protein may be, for example, sweet whey, acid whey, α-lactalbumin, β-lactoglobulin, bovine serum albumin, acid casein, caseinates, α-casein, β-casein and/or γ-casein. Suitable dairy substitute ingredients include soy proteins, rice proteins and combinations thereof, for example. In an embodiment, milk fat is present in the beverage in an amount from about 0% to about 1.5% of the beverage. In an embodiment, the milk fat is the only fat source in the beverage. For example, the beverage can have no added oil.

The stabilizing system has microcrystalline cellulose (MCC), carboxymethyl cellulose (CMC) and carrageenan. In a preferred embodiment, the carrageenan comprises kappa, iota and lambda carrageenan. In a preferred embodiment, the ratio of MCC to CMC is from about 1:1 to about 40:1 MCC:CMC, and the ratio of celluloses (MCC+CMC) to carrageenan is from about 0.3:1 to about 20:1 (MCC+CMC):carrageenan. Most preferably, the MCC is present in the beverage in an amount from about 0.02% to about 0.2% of the beverage, the CMC is present in the beverage in an amount from about 0.005% to about 0.25% of the beverage, and the carrageenan is present in the beverage in an amount from about 0.01% to about 0.075% of the beverage. In an embodiment, the MCC, CMC and carrageenan are the only the stabilizers in the beverage.

The beverage can be made aseptic to avoid or minimize spoiling. Aseptic treatment of the beverage may be performed by pre-heating the beverage, for example to about 75 to 85° C., and then injecting steam into the beverage to raise the temperature to about 140 to 160° C., for example at about 150° C. The beverage may then be cooled, for example by flash cooling, to a temperature of about 75 to 85° C., homogenized again, further cooled to about room temperature and filled into containers, such as cans. Suitable apparatuses for aseptic treatment of the beverage are commercially available. The stabilizing system can maintain the aseptic RTD dairy chocolate beverage in a homogenous state for at least nine months at 4° C., at least three months at 30° C. and at least one month at 38° C.

The combination of MCC, CMC and carrageenan in the disclosed ratios and amounts was found to assist in maintaining good suspension and emulsion stability of the beverage, avoiding syneresis and other phase separation issues during the storage, and improving mouthfeel. For example, the stabilizing system can maintain the cocoa component in suspension in an aqueous/dairy medium and stabilize proteins while also preventing or minimizing other phase separation issues.

The beverages can also include one or more additional ingredients such as flavorants, artificial sweeteners, natural sweeteners, colorants or a combination thereof Sweeteners can be sugar-based, such as sucrose, invert syrup, fructose syrup, glucose syrup with various DE, maltodextrins with various DE and combinations thereof, for example. Sugarless sweeteners can include, but are not limited to, sugar alcohols such maltitol, xylitol, sorbitol, erythritol, mannitol, isomalt and lactitol, hydrogenated starch hydrolysates, saccharin, cyclamate, acetosulfame, an L-aspartyl-based sweetener, or mixtures thereof

Usage level of the flavorants, sweeteners and colorants will vary greatly and will depend on such factors as potency of the sweetener, desired sweetness of the beverage, the level and type of flavor used, and cost considerations. Any suitable combinations of sugar and/or sugarless sweeteners may be used in the chocolate beverages. In an embodiment, sugar is present in an amount from about 0% to about 4.5% of the beverage, such as about 2% to about 4% of the beverage. For example, one serving of the beverage can include about 10 g of sugar. In an embodiment, the beverage does not have artificial sweetener.

In an embodiment, the beverage comprises the cocoa component in an amount from about 0.25% to about 1.0% of the beverage, the milk fat in an amount from about 0% to about 1.5% of the beverage, the sugar in an amount from about 2% to about 4% of the beverage; the MCC in an amount from about 0.02% to about 0.2% of the beverage; the CMC in an amount from about 0.005% to about 0.25% of the beverage; the carrageenan in an amount from about 0.01% to 0.075% of the beverage; and substantially all of the remainder of the beverage being milk.

Non-limiting examples of suitable flavorants include chocolate enhancers, cream/dairy enhancers, vanilla flavors or a combination thereof In an embodiment, the one or more flavorants are present in the beverage in an amount from about 0.1% to about 0.3% of the beverage.

The final composition can be adjusted to required acidity (pH) by one or more acidulants including but not limited to lactic acid, malic acid, citric acid, tartaric acid, phosphoric acid, glocono delta lactone and combinations thereof. In an embodiment, the one or more acidulants are present in the beverage at a total amount from about 0.01% to about 0.1% of the beverage.

In an embodiment, the beverage further includes one or more vitamins and/or minerals. The vitamins can be present in the beverage in an amount from about 0.01% to about 0.5% of the beverage. The vitamins include, but are not limited to, vitamin C and group B vitamins, and other non-limiting examples of suitable vitamins include ascorbic acid, ascorbyl palmitate, vitamins B1, B2, B6, B12, and Niacin (B3), or combination of thereof. The vitamins may also include Vitamins A, D, E and K and acid vitamins such as pantothenic acid, folic acid and biotin. The Vitamin A may be present as Vitamin A Palmitate. Vitamin D3 is an example of a suitable Vitamin D.

The minerals can be present in the beverage in an amount from about 0.0025% to about 1% of the beverage. Non-limiting examples of the minerals include calcium, magnesium, iron or a combination thereof. The source of calcium can include calcium carbonate, calcium phosphate, calcium citrate, other insoluble calcium compounds or a combination thereof. The source of magnesium can include magnesium phosphate, magnesium carbonate, magnesium hydroxide or combination of thereof. The source of iron can include iron ammonium phosphate, ferric pyrophosphate, ferric phosphate, ferrous phosphate, other insoluble iron compounds, aminoacids, iron chelating compounds such as EDTA, or combinations thereof. The minerals may also include zinc, iodine, copper, phosphorus, manganese, potassium, chromium, molybdenum, selenium, nickel, tin, silicon, vanadium and boron.

In an embodiment, the beverage further includes one or more amino acids. Non-limiting examples of amino acids include Isoleucine, Alanine, Leucine, Asparagine, Lysine, Aspartate, Methionine, Cysteine, Phenylalanine, Glutamate, Threonine, Glutamine, Tryptophan, Glycine, Valine, Proline, Serine, Tyrosine, Arginine, Histidine or combinations thereof.

In another embodiment, the beverage further includes one or more prebiotics. Non-limiting examples of prebiotics include fructooligosaccharides, inulin, lactulose, galactooligosaccharides, soyoligosaccharides, xylooligosaccharides, isomaltooligosaccharides, gentiooligosaccharides, lactosucrose, glucooligosaccharides, pecticoligosaccharides, resistant starches, sugar alcohols or a combination thereof.

The beverages can be made using any suitable process. For example, a process of making the chocolate beverages includes dissolving the raw materials in fluid milk/water and hydration (e.g., wetting) of a chocolate component such as cocoa powder for about 45 minutes to about 90 minutes at about 90° C. to about 95° C. to form the beverage. The beverage can then be subjected to ultra high temperature (“UHT”) heat treatment at about 140° C. to about 151° C. for about 2 seconds to about 12 seconds and aseptic homogenization from about 30 bars to about 300 bars. The UHT heat treatment can be followed by aseptic filling of the beverage into a suitable container.

### EXAMPLES

By way of example and not limitation, the following examples are illustrative of various embodiments of the present disclosure.

### Example 1

First, dry blend of 0.15% MCC, 0.05% CMC and 0.02% carrageenan with 3% sucrose were added to the tank containing fluid milk under high agitation. Secondly, 0.5% cocoa powders were hydrated at about 90° C. for 45 min, and then were added to the tank under continuous agitation. Small amount of skim milk powder was added to adjust the protein content to milk authenticity requirements. The liquid was pre-heated at about 75° C., then UHT treated for 5 sec at 150° C., cooled to about 75° C., homogenized at 200/50 bar, cooled to about 20° C. The product was aseptically filled into PET bottles. The beverage can be aseptically filled in any aseptic containers, e.g. Tetra Paks, jars, jugs or pouches.

Beverage physico-chemical properties were evaluated and sensory characteristics were judged by non-trained panelists. No phase separation including syneresis, gelation, marbleling and practically no sedimentation were found. It was found that the chocolate drink has good appearance and mouthfeel.

### Example 2

A chocolate beverage was prepared as in Example 1 but using 0.25% instead of 0.15% MCC in the beverage preparation. Beverage physico-chemical properties were evaluated and sensory characteristics were judged by non-trained panelists. Phase separation (sedimentation) was found.

### Example 3

A chocolate beverage was prepared as in Example 1 but using 0.25% instead of 0.05% CMC in the beverage preparation. Beverage physico-chemical properties were evaluated and sensory characteristics were judged by non-trained panelists. Very high

Instability Index was found, which corresponded to low physical stability (phase separation: mainly gelling, sedimentation) evaluated by visual observation of the product.

### Example 4

A chocolate beverage was prepared as in Example 1 but using 0.25% instead of 0.05% CMC, and 0.01% instead of 0.02% carrageenan in the beverage preparation. Beverage physico-chemical properties were evaluated and sensory characteristics were judged by non-trained panelists. Very high Instability Index was determined and phase separation (mostly gelling) was found by visual observation.

### Example 5

A chocolate beverage was prepared as in Example 1 but using 0.02% MCC, 0.005% CMC, and 0.1% carrageenan in the beverage preparation. Beverage physico-chemical properties were evaluated and sensory characteristics were judged by non-trained panelists. High Instability Index indicating phase separation was determined. Unacceptable high viscosity and gelling were found.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A beverage comprising:
a dairy component;
a cocoa component; and
a stabilizing system comprising microcrystalline cellulose (MCC), carboxymethyl cellulose (CMC) and carrageenan.

2. The beverage according to claim 1, wherein: the MCC and the CMC are present in a ratio from about 1:1 to about 40:1 MCC:CMC; and the MCC+CMC and the carrageenan are present in a ratio from about 0.3:1 to about 20:1 (MCC+CMC):carrageenan.

3. The beverage according to claim 1, wherein the MCC is present in an amount from about 0.02% to about 0.2% of the beverage, the CMC is present in an amount from about 0.005% to 0.25% of the beverage, and the carrageenan is present in an amount from about 0.01% to 0.075% of the beverage.

4. The beverage according to claim 1, wherein the carrageenan comprises kappa, iota and lambda carrageenan.

5. The beverage according to claim 1, wherein the cocoa component is present in an amount from about 0.25% to about 1.0% of the beverage.

6. The beverage according to claim 1, wherein sugar is present in the beverage in an amount from about 2% to about 4% of the beverage.

7. The beverage according to claim 1, wherein the cocoa component is selected from the group consisting of natural cocoa, alkalized cocoa and combinations thereof.

8. The beverage according to claim 1, wherein milk fat is present in the beverage in an amount from about 0% to about 1.5% of the beverage.

9. The beverage of claim 8, wherein the milk fat is the only fat in the beverage.

10. The beverage according to claim 1, wherein the beverage comprises the cocoa component, the MCC, the CMC, the carrageenan, milk fat and sugar, and substantially all of the remainder of the beverage is milk.

11. A ready to drink aseptic beverage comprising:
a dairy component;
a cocoa component; and
a stabilizing system comprising microcrystalline cellulose (MCC), carboxymethyl cellulose (CMC) and carrageenan, wherein the MCC and the CMC are present in a ratio from about 1:1 to about 40:1 MCC:CMC, and the MCC+CMC and the carrageenan are present in a ratio from about 0.3:1 to about 20:1 (MCC+CMC):carrageenan; and the stabilizing system maintains the aseptic chocolate beverage in a homogenous state for at least nine months at 4° C.

12. The beverage according to claim 11, wherein the MCC is present in an amount from about 0.02% to about 0.2% of the beverage, the CMC is present in an amount from about 0.005% to about 0.25% of the beverage, and the carrageenan is present in an amount from about 0.01% to about 0.075% of the beverage.

13. The beverage according to claim 11, comprising an amount of sugar reduced by about 40% or more and an amount of fat reduced by about 40% or more relative to typical shelf-stable ready to drink beverages containing cocoa and dairy.

14. A method of producing a ready to drink dairy chocolate beverage comprising the steps of adding a stabilizing system to a dairy component and a cocoa component, the stabilizing system comprising microcrystalline cellulose (MCC), carboxymethyl cellulose (CMC) and carrageenan.

15. The method of claim 14, wherein: the MCC and the CMC are present in a ratio from about 1:1 to about 40:1 MCC:CMC; and the MCC+CMC and the carrageenan are present in a ratio from about 0.3:1 to about 20:1 (MCC+CMC):carrageenan.
